(19) United States
(12) Patent Application Publication
(10) Pub. No.: US 2005/0218875 A1
(43) Pub. Date: Oct. 6, 2005

(54) Portable electronic device capable of supplying a predetermined voltage output

(75) Inventors: Wen-Chi Chen, Jung-He City (TW); Chung-Wen Chen, Jung-He City (TW); Chun-Chang Yang, Jung-He City (TW)

Correspondence Address: LADAS & PARRY, 26 WEST 61ST STREET, NEW YORK, NY, 10023, US

(73) Assignee: MICRO-STAR INTERNATIONAL CO., LTD.

(21) Appl. No.: 11/091,190

(22) Filed: Mar. 28, 2005

(30) Foreign Application Priority Data
Apr. 6, 2004 (TW) 093109450

(51) Int. Cl. G05F 1/40

(52) U.S. Cl. 323/282

(57) ABSTRACT

A portable electronic device includes a DC power converting circuit coupled electrically to a power supplying unit for converting a DC power supplied by the power supplying unit into a predetermined voltage output, and a control unit coupled electrically to the DC power converting circuit and an output interface. The control unit is operable so as to control the portable electronic device to operate in one of a power supplying mode, where the control unit makes connection between the DC power converting circuit and the output interface such that the predetermined voltage output from the DC power converting circuit is outputted via the output interface, and a non-power supplying mode, where the control unit interrupts connection between the DC power converting circuit and the output interface.

### CROSS-REFERENCE TO RELATED APPLICATION

This application claims priority of Taiwanese Application No. 093109450,

filed on Apr. 6, 2004.

### BACKGROUND OF THE INVENTION

1. Field of the Invention

The invention relates to a portable electronic device, more particularly to a portable electronic device capable of supplying a predetermined voltage output.

2. Description of the Related Art

In a conventional electronic device, such as a personal computer, a notebook computer, a personal digital assistant, a digital camera, an MP3 player, etc., a USB interface is used for data transmission with another electronic device.

Presently, a conventional desktop computer can provide a voltage output to an external electronic device via a USB interface thereof when the conventional desktop computer is operated in an ON-state.

### SUMMARY OF THE INVENTION

Therefore, the object of the present invention is to provide a portable electronic device that can supply a predetermined voltage output.

According to the present invention, a portable electronic device comprises:

a power supplying unit for supplying a DC power;

a DC power converting circuit coupled electrically to the power supplying unit for converting the DC power supplied by the power supplying unit into a predetermined voltage output;

an output interface; and

a control unit coupled electrically to the DC power converting circuit and the output interface, the control unit being operable so as to control the portable electronic device to operate in one of a power supplying mode, where the control unit makes connection between the DC power converting circuit and the output interface such that the predetermined voltage output from the DC power converting circuit is outputted via the output interface, and a non-power supplying mode, where the control unit interrupts connection between the DC power converting circuit and the output interface.

### BRIEF DESCRIPTION OF THE DRAWINGS

Other features and advantages of the present invention will become apparent in the following detailed description of the preferred embodiment with reference to the accompanying drawing, of which:

FIG. 1 is a schematic circuit block diagram illustrating the preferred embodiment of a portable electronic device according to the present invention.

### DETAILED DESCRIPTION OF THE PREFERRED EMBODIMENT

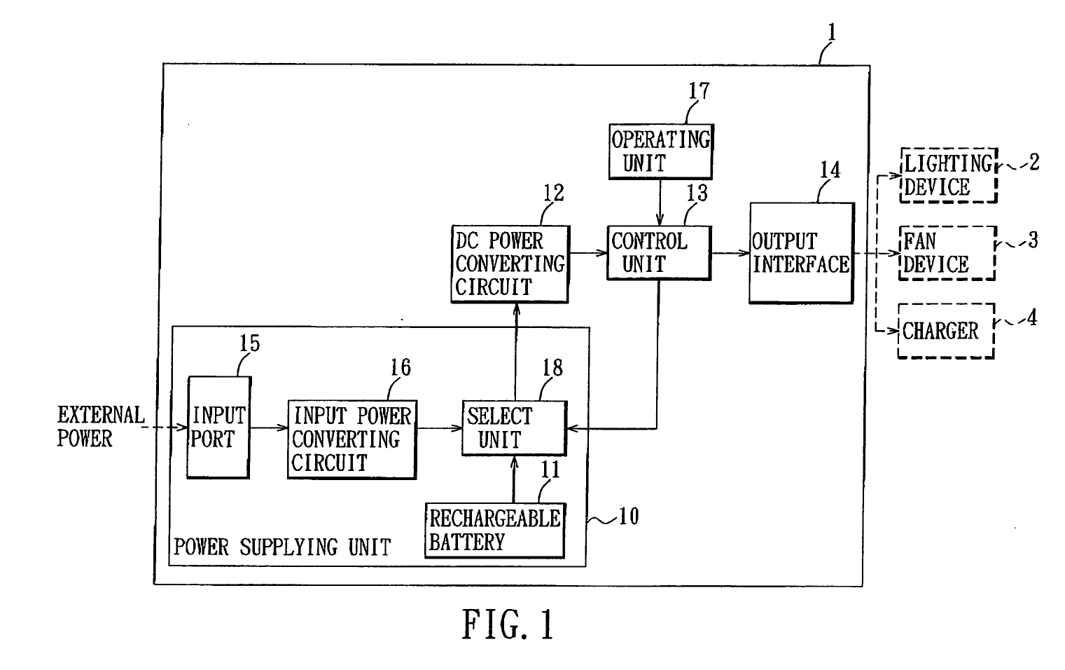

Referring to FIG. 1, the preferred embodiment of a portable electronic device 1 according to the present invention is shown to include a power supplying unit 10, a DC power converting circuit 12, an output interface 14, and a control unit 13. In this embodiment, the portable electronic device 1 can be a notebook computer or a personal digital assistant.

The power supplying unit 10 supplies a DC power. In this embodiment, the power supplying unit 10 includes a rechargeable battery 11, an input port 115, an input power converting circuit 16, and a select unit 18. The rechargeable battery 11 is capable of supplying a first DC power. The input port 15 is adapted for receiving an external power that is generated from an AC adapter (not shown). The input power converting circuit 16 is coupled electrically to the input port 15 for converting the external power into a second DC power. The select unit 18 is coupled electrically to the rechargeable battery 11, the input power converting circuit 16 and the DC power converting circuit 12, receives the first and second DC powers from the rechargeable battery 11 and the input power converting circuit 11, respectively, when the external power is supplied to the input port 15, and outputs a selected one of the first and second DC powers as the DC power.

The DC power converting circuit 12 is coupled electrically to the select unit 18 of the power supplying unit 10 for converting the DC power supplied by the power supplying unit 10 into a predetermined voltage output.

The output interface 14, which can be one of a USB interface and a PS/2 interface in this embodiment, is adapted to be connected to an external electronic device, such as a lighting device 2, a fan device 3 or a charger 4 for a mobile phone.

The control unit 13 is coupled electrically to the DC power converting circuit 12 and the output interface 14. The control unit 13 is operable so as to control the portable electronic device 1 to operate in one of a power supplying mode, where the control unit 13 makes connection between the DC power converting circuit 12 and the output interface 14 such that the predetermined voltage output from the DC power converting circuit 12 is outputted via the output interface 14, and a non-power supplying mode, where the control unit 13 interrupts connection between the DC power converting circuit 12 and the output interface 14. In this embodiment, the predetermined voltage output is substantially a 5-volt voltage output that is adapted to be applied to the external electronic device. It is noted that the control unit 13 is operable so as to control the select unit 18 to output the selected one of the first and second DC powers as the DC power.

The portable electronic device 1 further includes an operating unit 17 coupled electrically to the control unit 13 and operable so as to generate a control signal. The control unit 13 performs control of the portable electronic device 1 and the select unit 18 in accordance with the control signal from the operating unit 17.

In actual use, when the portable electronic device 1 is operated outdoors in the power supplying mode, the select unit 18 is responsive to control by the control unit 13 in accordance with the operation of the operating unit 17 such that the first DC power is output as the DC power to the DC power converting circuit 12. On the other hand, when the portable electronic device 1 of this invention is operated indoors in the power supplying mode, the select unit 18 is responsive to control by the control unit 13 in accordance with the operation of the operating unit 17 such that the selected one of the first and second DC powers is output as the DC power to the DC power converting circuit 12.

To sum up, the portable electronic device 1 of this invention can supply the predetermined voltage output to the external electronic device regardless of indoor or outdoor use, thereby resulting in improved functionality.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A portable electronic device comprising:
a power supplying unit for supplying a DC power;
a DC power converting circuit coupled electrically to said power supplying unit for converting the DC power supplied by said power supplying unit into a predetermined voltage output;
an output interface; and
a control unit coupled electrically to said DC power converting circuit and said output interface, said control unit being operable so as to control said portable electronic device to operate in one of a power supplying mode, where said control unit makes connection between said DC power converting circuit and said output interface such that the predetermined voltage output from said DC power converting circuit is outputted via said output interface, and a non-power supplying mode, where said control unit interrupts connection between said DC power converting circuit and said output interface.

2. The portable electronic device as claimed in claim 1, wherein said power supplying unit includes:
a rechargeable battery capable of supplying a first DC power;
an input port adapted for receiving an external power;
an input power converting circuit coupled electrically to said input port for converting the external power into a second DC power; and
a select unit coupled electrically to said rechargeable battery, said input power converting circuit, said DC power converting circuit and said control unit, said select unit receiving the first and second DC powers from said rechargeable battery and said input power converting circuit, respectively, when the external power is supplied to said input port;
said control unit being operable so as to control said select unit to output a selected one of the first and second DC powers as the DC power.

3. The portable electronic device as claimed in claim 2, further comprising
an operating unit coupled electrically to said control unit, and operable so as to generate a control signal,
said control unit performing control of said portable electronic device and said select unit in accordance with the control signal from said operating unit.

4. The portable electronic device as claimed in claim 1, wherein the predetermined voltage output is substantially a 5-volt voltage output.

5. The portable electronic device as claimed in claim 1, wherein said output interface is a USB interface.

6. The portable electronic device as claimed in claim 1, wherein said output interface is a PS/2 interface.

7. The portable electronic device as claimed in claim 1, wherein said portable electronic device is a notebook computer.

8. The portable electronic device as claimed in claim 1, wherein said portable electronic device is a personal digital assistant.
